(19) United States
(12) Patent Application Publication
(10) Pub. No.: US 2009/0229077 A1
(43) Pub. Date: Sep. 17, 2009

(54) ABSORPTION MECHANISM FOR FURNITURE DOORS

(76) Inventor: Horst Lautenschlager, Reinheim (DE)

Correspondence Address: WRB-IP LLP, 1217 KING STREET, ALEXANDRIA, VA, 22314, US

(21) Appl. No.: 12/417,517

(22) Filed: Apr. 2, 2009

Related U.S. Application Data
(63) Continuation-in-part of application No. 12/186,700, filed on Aug. 6, 2008.

(30) Foreign Application Priority Data
Mar. 13, 2008 (DE) 102008013986.6-31
Feb. 19, 2009 (DE) 102009009563.2

(51) Int. Cl. E05F 5/10

(52) U.S. Cl. 16/84

(57) ABSTRACT

A damping device for furniture door leaves includes a damping housing that accommodates a damping cylinder, with the housing being connected to a damping carrier that is fastened to a front frame of a furniture piece, wherein the damping carrier accommodates the edge of the front frame between an outside retaining leg and an inside clamping leg and the clamping leg is clamped against the front frame by way of a clamping device. The damping carrier includes a carrier main component that forms an outside retaining leg and a spring component that forms the inside clamping leg and the spring component includes a fastening leg offset at a right angle from the clamping leg that is inserted into a fastening guide of the carrier main component and locks positively on the carrier main component.

### BACKGROUND AND SUMMARY

The present application is a continuation-in-part of U.S. application Ser. No. 12/186,700, filed Aug. 6, 2008, which claims priority to German Application 10 2008 013 986.6, filed Mar. 13, 2008, the disclosures of both of which are incorporated by reference.

The invention relates to a damping device for furniture door leaves comprising a damping housing that accommodates a damping cylinder, with the housing being connected to a damping carrier that is fastened to a front frame of a piece of furniture . . . (Patent Application 10 2008 013 986.6)

Such damping devices dampen the closing motion of furniture door leaves to prevent sudden, forceful contact of the door leaf with the body of the piece of furniture or its front frame. It is known to connect door hinges of the door leaves with the damping devices. However, this design does not allow for retrofitting door hinges that initially do not have any damping devices. Furthermore, this design requires that all door hinges be equipped with damping devices regardless of whether or not damping devices are needed. If it is necessary to subsequently retrofit a door leaf with a damping device, the entire door hinge must be replaced.

To avoid these disadvantages, it is known to fasten the damping devices so that they can be removed from door hinges or so that the door hinges can be retrofitted with them. To this end, however, it is necessary to install the required fastening elements for a damping device to the door hinges (U.S. Pat. No. 6,591,454 B2). If door hinges are not designed in this manner for retrofitting purposes for a damping device, it is not possible to retrofit the hinge.

It is desirable to provide a damping device as described in the introduction that can be attached independent of the door hinges that are used.

According to an aspect of the present invention, a damping carrier accommodates the edge of the front frame between an outside retaining leg and an inside clamping leg and in that the clamping leg is clamped against the front frame by way of a clamping device.

The resulting clamping connection between the damping carrier of the damping device and the front frame of the furniture piece makes it possible to easily install the damping device either during the initial assembly of the furniture piece or as part of a retrofit without requiring any bores or screws.

Clamp fitting the damping carrier to the front frame of the furniture piece results in a stable connection that is suitable for transferring even high damping forces. The damping device can be removed from the furniture piece again without leaving any screw holes or other damage.

The damping device can easily be retrofitted to furniture pieces with any kind of door hinge.

It also is possible to subsequently remove or move damping devices.

The simple fastening manner of this damping device also allows for an adjustment to different damping requirements of a furniture piece. For example, it is possible to use multiple damping devices for large and heavy furniture door leaves, while a single damping device suffices for light and small furniture door leaves. For cost saving reasons or for adjusting to different uses, it is possible to remove the originally installed damping devices from individual furniture door leaves, or to not install them at all.

According to the additional patent the embodiment of the inventive thought of the original patent requires that the damping carrier be comprised of a carrier main component that forms the outside retaining leg and of a spring component that forms the inside clamping leg and that the spring component comprises a fastening leg that is offset at a right angle from the clamping leg and is inserted into a fastening guide of the carrier main component and locks positively on the carrier main component.

This two-part embodiment of the damping carrier provides for an easier installation. Since the carrier main component forms the outside retaining leg, the damping force is supported directly by the carrier main component by way of the retaining leg on the furniture body or its front frame respectively.

The spring component that forms the clamping leg is inserted into the fastening guide of the carrier main component during the pre-installation of the damping device and then is locked positively on it. This provides for the required cohesion of the two components of the damping carrier that is necessary for transferring the clamping force.

According to a preferred embodiment of the invention, the fastening leg of the spring component is inserted into the fastening guide in clamping direction and comprises a resilient locking latch that latches with a latch indentation of the carrier main component and locks the fastening leg so it cannot be pulled out.

The damping device can easily be installed by inserting the fastening leg of the spring component into the carrier main component until there is a positive lock.

The fastening guide preferably comprises two guide beads that project in opposite direction and that overlap the side edges of the fastening leg.

### BRIEF DESCRIPTION OF THE DRAWINGS

The invention is explained in more detail based on exemplary embodiments that are shown in the drawing. The following is shown:

FIG. 1 shows a section of a damping device for furniture door leaves,

FIG. 2 shows the damping device according to FIG. 1 before it is installed,

FIG. 3 shows the damping device according to FIG. 1 before it is clamped on,

FIG. 4 shows a section along line IV-IV in FIG. 3,

FIG. 5 shows a top view of the spring component of the damping device according to FIG. 1-3,

FIG. 6 shows a section of a modified embodiment of a damping device when it is installed,

FIG. 7 shows a damping device according to FIG. 6 before it is clamped on,

FIG. 8 shows a section of the carrier main component of the damping carrier of the damping device according to FIG. 6,

FIG. 9 shows the spring component of the damping carrier of the damping device according to FIG. 6,

FIG. 10 shows a top view in the direction of arrow X in FIG. 9,

FIG. 11 shows another modified embodiment of the damping device in a presentation according to FIG. 7,

FIG. 12 shows the damping device according to FIG. 11 when it is installed according to FIG. 6,

FIG. 13 shows a section according to FIG. 8 through the carrier main component of the damping device according to FIGS. 11 and 12, and

FIG. 14 shows a section according to FIG. 9 through the spring component of the damping carrier of the damping device according to FIGS. 11 and 12.

### DETAILED DESCRIPTION

The damping device 1 shown in FIG. 1 through 3 is used to dampen the closing motion of a door leaf 2 and that is arranged in a pivoting manner on a front frame 3 of a furniture body 4 by way of a door hinge.

A damping cylinder 5, comprising a damping piston and a piston rod 6, is inserted into a location hole 7 of a damping housing 8 so it can be longitudinally displaced. The cylinder end 9 that extends from the location hole 7 on the side of the door constitutes a stop for the door leaf 2. Right before the end of its closing motion, the door leaf 2 makes contact with the cylinder end 9 that extends from the location hole 7 and moves the damping cylinder 5 towards the face end of the location hole 7, with the damping cylinder 5 resting on an adjusting screw 10 of the damping housing 8 by way of its piston rod 6. In doing so the damping force, which is determined by speed, counteracts the closing motion of the door leaf 2.

The damping housing 8 is fastened to a two-component damping carrier 11. The damping carrier 11 comprises a carrier main component 12 which is integrally formed with the damping housing 9 and forms a retaining leg 13 that rests on the outside of the front frame 3, and of a spring component 14 that forms an inside clamping leg 15. An eccentric 17 is arranged in a pivoting, manner on two lateral bearing journals 18 between lateral cheeks 16 of the spring component 14. The eccentric 17 is integrally connected to a pivoting lever 19 that extends into the inside of the furniture body.

As is shown in FIG. 1, the damping device is assembled and clamped to the front frame 3 of the furniture body 4. The outside retaining leg 13 as well as the inside clamping leg 15 have teeth 20, 21 that protrude towards the front frame 3 and penetrate the front frame 3.

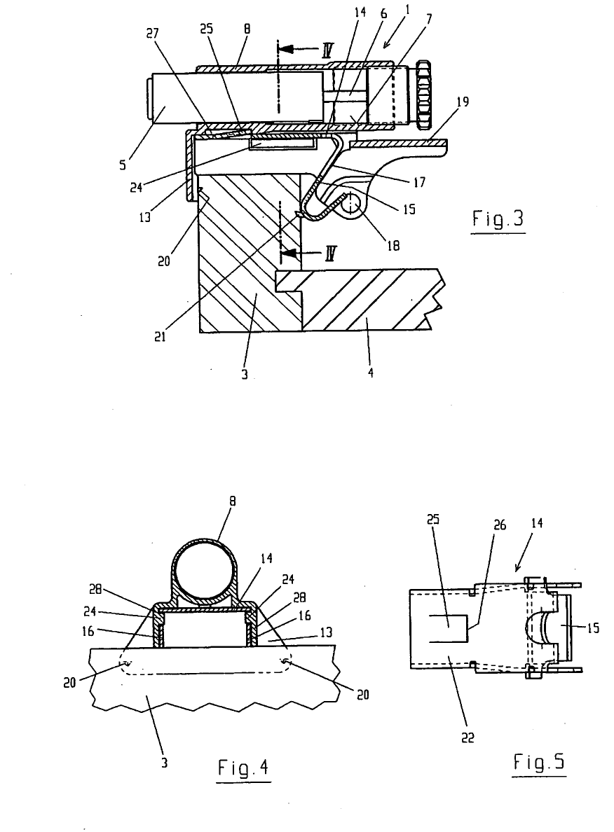

When the eccentric 17 is pivoted counterclockwise from the pre-installed position shown in FIG. 3 into the final position shown in FIG. 1 by means of the pivoting lever 19, the eccentric 17 pushes the resilient elastic clamping leg 15 against the inside of the front frame 3 so that the two-component damping carrier 11, together with the damping housing 8 that is fastened to it, rests tightly against the front frame 3.

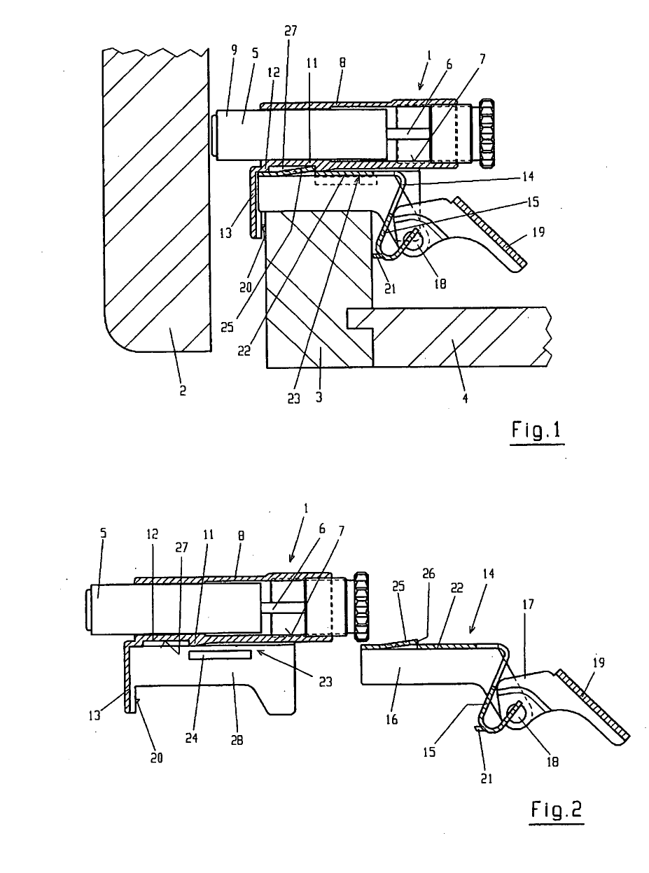

As can be seen clearly in FIG. 2, the spring component 14 comprises a fastening leg 22 that is offset at a right angle from the clamping leg 15 and that is inserted into a fastening guide 23 of the carrier main component 12 and locks positively on it.

In the installation process shown in FIG. 2 the fastening leg 22 of the spring component 14 is inserted into the fastening guide 23 in clamping direction, i.e. to the left in FIG. 2. The fastening guide 23 comprises two guide beads 24 that project in opposite direction and that overlap the side edges of the fastening leg 22 when installed.

To fasten the fastening legs 22 positively in the carrier main component 12, a resilient locking latch 25 extends upward from the fastening leg 22 and inclines against the insertion direction of the fastening leg 22 to a locking edge 26. After the fastening leg 22 is inserted into the carrier main component 12, the locking latch 25 latches with the latch indentation 27 of the carrier main component 12 as is shown in FIGS. 1 and 3 and locks the fastening leg 22 so it cannot be pulled out.

The pre-installation of the damping device thus does not require any tools. The components of the damping device are secured against loosening. In this preinstalled state the damping device 1 is placed on the furniture piece and is clamped on.

The carrier main component 12 has two lateral cheeks 28 from the inside of which the guide beads 24 protrude. The lateral cheeks 28 simultaneously form the lateral guides for the cheeks 16 of the spring component 14 that are arranged between them.

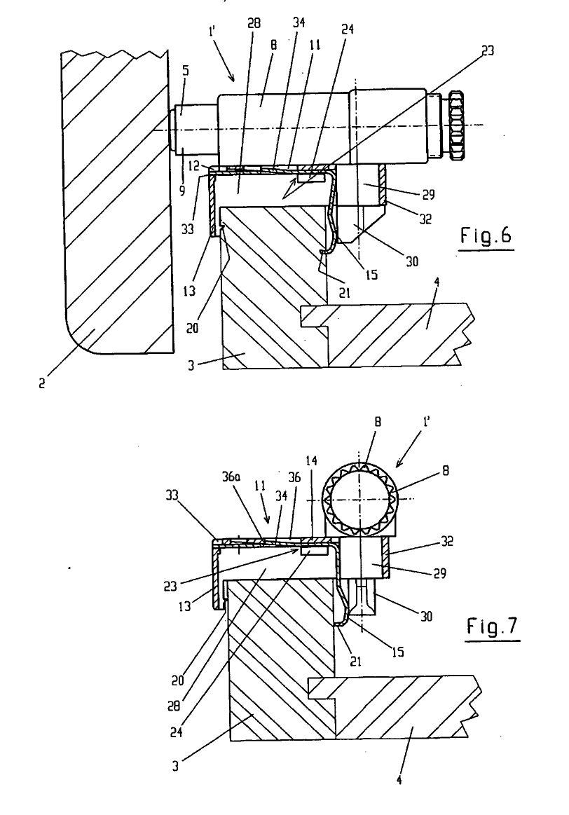

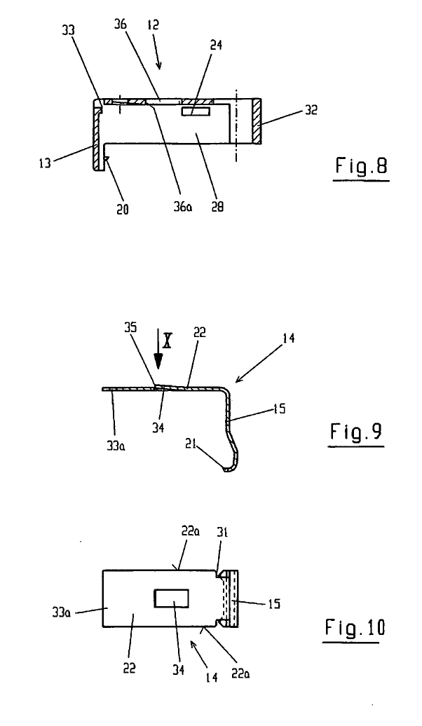

FIG. 6-10 shows a modified embodiment of a damping device 1′. It is different from the above-described embodiment substantially in that the damping housing 8 pivots relative to the damping carrier 11. The damping housing 8 is connected to an eccentric 30 by way of a connecting piece 29 with the eccentric pushing onto the resilient clamping leg 15 when the damping housing 8 is pivoted by 90° from the position shown in FIG. 7 into the position shown in FIG. 6.

Deviating from the above-described exemplary embodiment, the spring component 14, when installed, rests on the connecting piece 29. The fastening leg 22 comprises an insertion section 31 (FIG. 10) whose width is smaller than the inside width between the guide beads 24.

Since it is not possible to insert the spring component 14 as described above due to a bearing shell 32 for the connecting piece 29 that is arranged on the carrier main component 12, the spring component 14 is inserted through a slot 33 with the free end 32 of the fastening leg 22, with said slot being arranged on the bottom of the retaining leg 13. In this position the insertion section 31 fits between the two guide beads 24. Then the spring component 14 is moved to the right until its clamping leg rests against the connecting piece 29 or its bearing sleeve 32, respectively. In this position shown in FIGS. 6 and 7 the two lateral edges 22a of the fastening leg 22 are disposed over the guide beads 24. The free end 32 of the fastening leg 22 is located in slot 33. The fastening leg 22 of the spring component 14 thus is inserted into the fastening guide against the clamping direction until it hits a stop. A resilient locking latch 34 that extends from the fastening leg 22 inclines upward in the direction of the free end 32 up to a locking edge 35. Once the fastening leg 22 is brought into its final position as described, the locking latch 34 latches behind a latch edge 36a comprised of a latch indentation 36 of the carrier main component 12 and locks the fastening leg 22 in clamping direction so that the spring component 14 is fastened in its preinstalled position.

In this preinstalled position according to FIG. 7 the damping device 1′ can be placed on the front frame 3 of the furniture body 4 and can be clamped in the position shown in FIG. 6 by turning the damping housing 8.

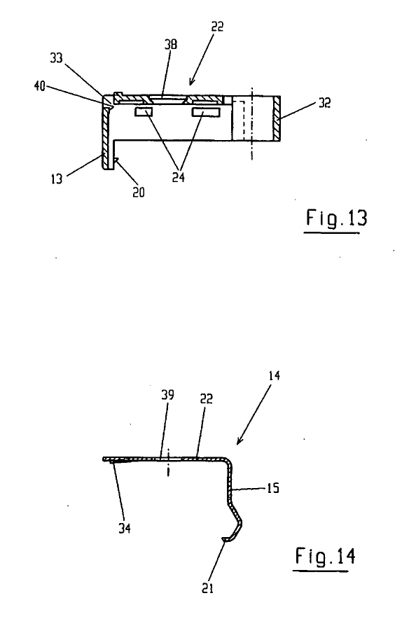

The embodiment shown in FIG. 11-14 is different from the damping device according to FIG. 6-10 in that a fastening screw 37 is screwed into the front frame 3 through a screw bore 38 of the carrier main component 12 and a screw bore 39 of the fastening leg 22 of the spring component 14.

Deviating from the above-described embodiment the resilient locking latch 34 extends from the bottom near the free end of the fastening leg 22 of the spring component 14. A latch edge 40 in which the locking latch 34 latches, is formed at the edge of the slot 33 on the upper edge of the outside retaining leg 13.

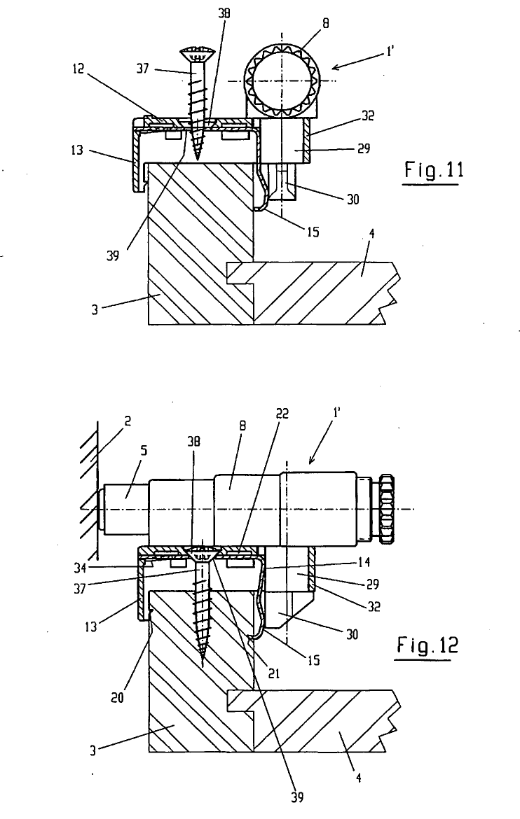

The damping device is placed onto the front frame 3 as is shown in FIG. 11. The damping housing 8 is pivoted so that it extends parallel to the front frame 3 and thus at a right angle to the longitudinal direction of the carrier main component 12. In this position the screw bores 38 and 39 are accessible from the top and the fastening screw 32 can be screwed into the front frame 3 as is shown in FIG. 11. Then the damping housing 8 is pivoted into the final position shown in FIG. 12. As already described for FIG. 6, the front frame 3 is clamped between the outside retaining leg 13 and the clamping leg 15. At the same time, the fastening screw 37 is covered.

The fastening screw 37 secures the damping device 1′ on the front frame when high damping forces occur. This relieves the clamping of the damping device.

The resilient locking latch 34 that latches behind the latch edge 14 secures the spring component 13 in its position on the bottom of the carrier main component 12 even before it is installed.

1. Damping device for furniture door leaves comprising a damping housing that accommodates a damping cylinder, with the housing being connected to a damping carrier that is fastened to a front frame of a furniture piece, wherein the damping carrier accommodates the edge of the front frame between an outside retaining leg and an inside clamping leg and the clamping leg is clamped against the front frame by way of a clamping device wherein the damping carrier comprises a carrier main component that forms an outside retaining leg and a spring component that forms the inside clamping leg and the spring component comprises a fastening leg offset at a right angle from the clamping leg that is inserted into a fastening guide of the carrier main component and locks positively on the carrier main component.

2. Damping device according to claim 1, wherein the fastening leg of the spring component is inserted into the fastening guide in clamping direction and comprises a resilient locking latch that latches with a latch indentation of the carrier main component and locks the fastening leg so it cannot be pulled out.

3. Damping device according to claim 1, wherein the fastening guide comprises two guide beads that project in opposite direction that overlap the side edges of the fastening leg.

4. Damping device according to claim 3, wherein the fastening leg comprises an insertion section whose width is smaller than the inside width between the guide beads.

5. Damping device according to claim 4, wherein the fastening leg of the spring component is inserted into the fastening guide against clamping direction until it hits a stop and comprises a resilient locking latch that latches on a latch edge of the carrier main component and locks the fastening leg in clamping direction.

6. Damping device according to claim 5, wherein the resilient locking latch extends on the upper side of the fastening leg and the latch edge is comprised of a latch indentation of the carrier main component.

7. Damping device according to claim 5, wherein the resilient locking latch extends from the bottom near the free end of the fastening leg and the latch edge is formed on the edge of the slot of the outside retaining leg.

8. Damping device according to claim 1, wherein a fastening screw is screwed into the front frame through a screw bore of the carrier main component and a screw bore of the fastening leg of the spring component.
